(19) United States
(12) Patent Application Publication
(10) Pub. No.: US 2009/0099927 A1
(43) Pub. Date: Apr. 16, 2009

(54) SYSTEM AND METHOD FOR SUBSCRIPTION-BASED ADVERTISING

(75) Inventors: Brad STEWART, Wakefield (CA); Mark NORTHCOTT, Ottawa (CA); Dave KLEIN, Ottawa (CA)

Correspondence Address: LANG MICHENER, BCE PLACE, P.O. BOX 747, SUITE 2500, 181 BAY STREET, TORONTO, ON, M5J 2T7, CA

(73) Assignee: Paymail, Inc., Ottawa (CA)

(21) Appl. No.: 12/252,417

(22) Filed: Oct. 16, 2008

(30) Foreign Application Priority Data
Oct. 16, 2007 (CA) 2606689

(51) Int. Cl. G06Q 30/00

(52) U.S. Cl. 705/14

(57) ABSTRACT

The invention comprises a method of providing reward-compensated advertising, comprising: a) registering one or more advertisers with a service provider; b) registering one or more users with the service provider; c) selecting individual users to view content from individual advertisers based on the reward level set by the individual user; and d) compensating the individual user for viewing the advertising content based on the reward level set by the advertiser.

### FIELD OF THE INVENTION

The present invention relates to the field of advertising. In particular, it relates to a system of subscription-based Internet advertising.

### BACKGROUND OF THE INVENTION

Many systems and methods of advertising have been developed in accordance with developments in technology. With the rapid increase in individual consumer usage of the Internet, many attempts to capitalize with advertising methods have been proposed and implemented. However, these methods are based on traditional print, radio and television advertising methods, where the user is both captive to the media and passively engaged by the advertisement. Users of the Internet are neither captive nor passive and thus, there is a need for a system and method of advertising that is capable of capitalizing on those attributes.

One previously proposed method is targeted traffic redirection. Users are directed to a specific advertising webpage and compensated based on viewing for a fixed period of time. Currently known examples include Clixsense.com and adbux.org. This method is limited by the need to create a secure, customized webpage for each advertisement, as well as the need to accurately and securely track the duration of the user's visit to the page. To date, this method has seen limited support from both advertisers and users.

Another proposed method is advertising delivery via email. Users are compensated for receiving advertisements via authorized email messages. A currently known example is boxbe.com. This method is limited by the support of the user's email provider and can potentially be blocked by systems outside the user's control. A variant on this system is the New Zealand-based buzzshed.com, which emails a user links to video clips and other content, and then compensates the user for viewing the linked content. Again, buzzshed is limited by the email delivery system for contacting the user.

Yet another variant is promoted by Imagiin.com, based in France, where users log in to the Imagiin website to watch videos, and then are compensated for responding to a questionnaire or survey following the end of the video. Imagiin is limited by requiring the user to log in directly to the Imagiin website, and does not provide any means for alternate content delivery.

Still another variant is promoted by BrandPort, where users collect points for viewing advertisements and completing surveys and apply the points to contest entries. The advertisements are hosted by BrandPort on a weekly rotation and are not targeted to any user information, other than whether the advertisement was previously viewed. While BrandPort provides an accountable compensation system, there is still a need for effective, targeted advertising content.

Other areas include data-aggregation tools, which collect information based on a user's webpage visitation history, and provide the aggregated information to advertisers for targeting purposes. Users are compensated in varying degrees for providing their information. These tools are currently and foreseeably limited to data aggregation, and do not provide for any direct contact between users and advertisers.

It is an object of this invention to partially or completely fulfill one or more of the above-mentioned needs.

### SUMMARY OF THE INVENTION

The invention comprises a method of providing reward-compensated advertising, comprising: a) registering one or more advertisers with a service provider; b) registering one or more users with the service provider; c) selecting individual users to view content from individual advertisers based on the reward level set by the individual user; and d) compensating the individual user for viewing the advertising content based on the reward level set by the advertiser.

Preferably, the user is permitted to assign their compensation to a third party.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a flow chart outlining a preferred method of the present invention;

FIG. 2 is a schematic of the user and advertiser sign-up process of the present invention;

FIG. 3 is a schematic of the advertising query and qualification process of the present invention;

FIG. 4 is a schematic of payment process of the present invention; and

FIG. 5 is a schematic of the redemption process of the present invention.

### DETAILED DESCRIPTION OF THE PREFERRED EMBODIMENT

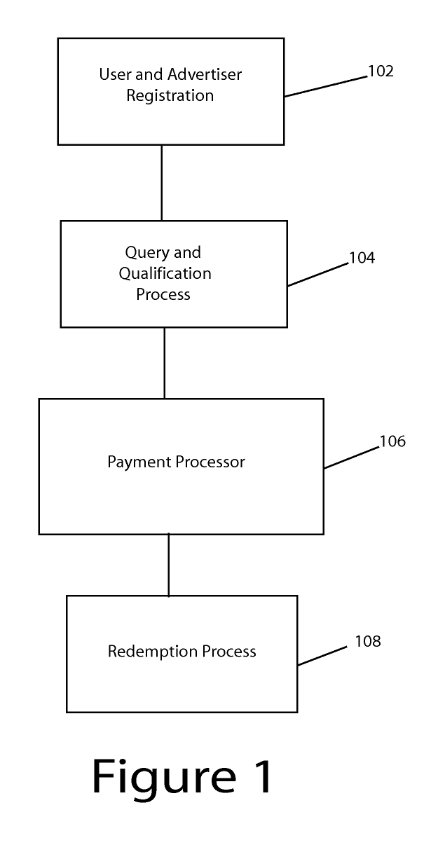

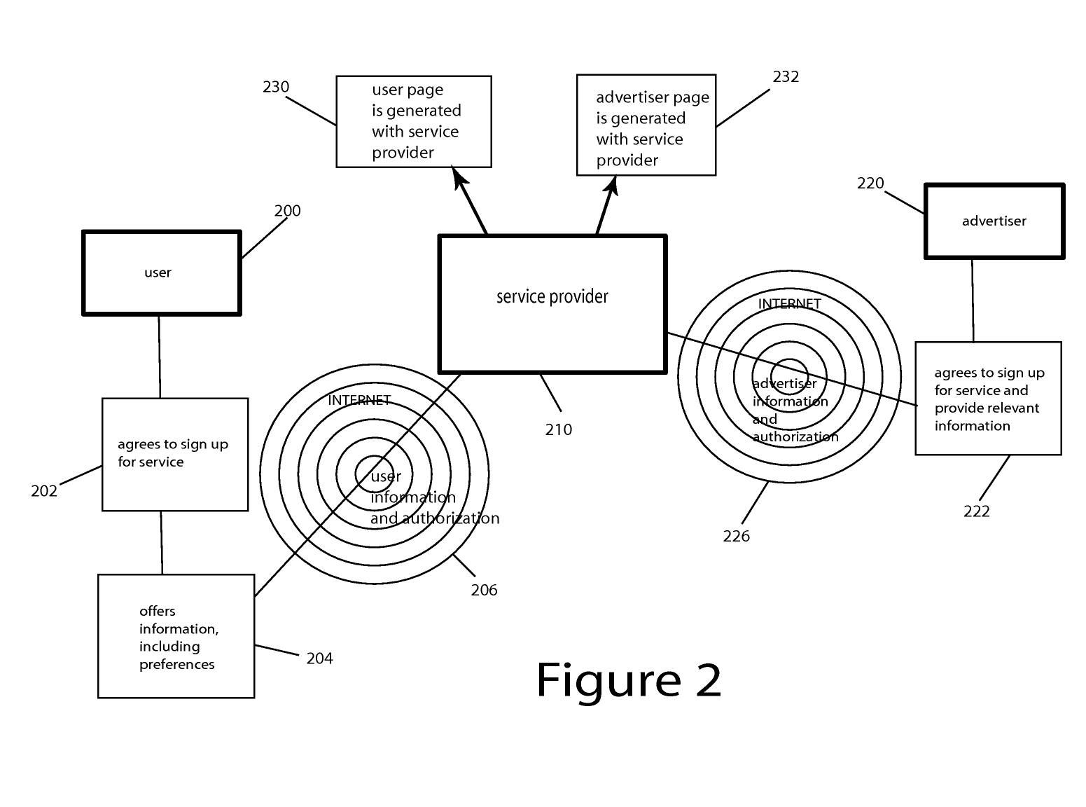

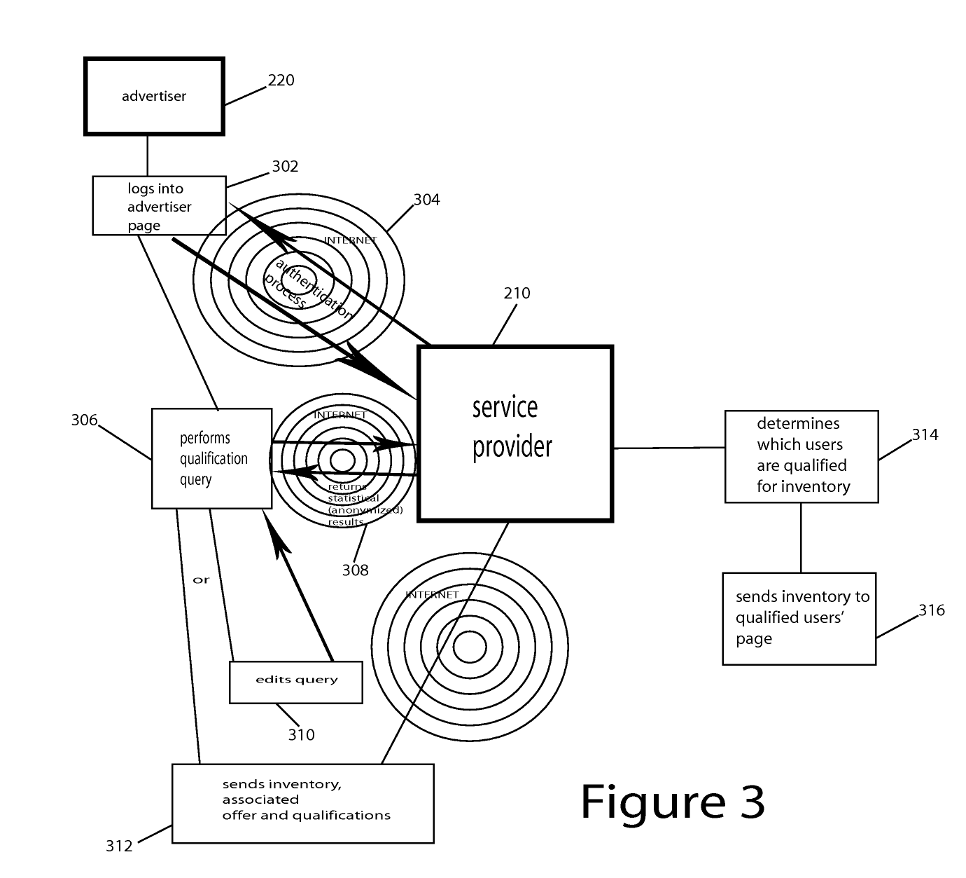

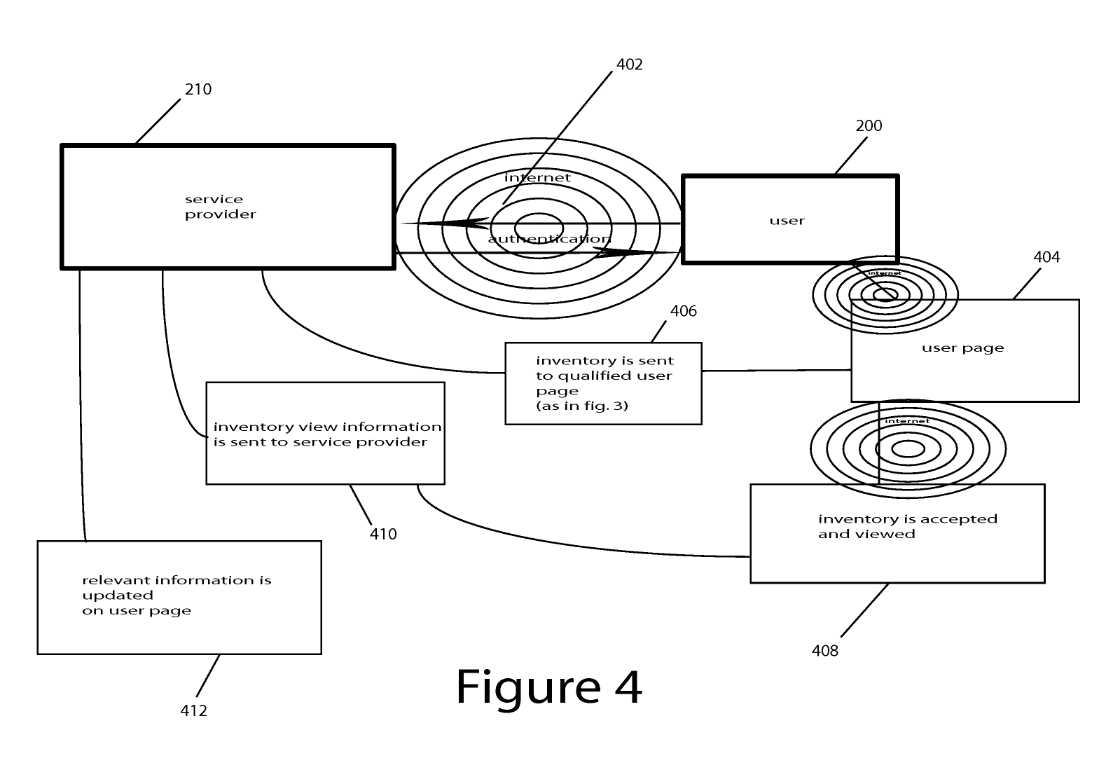

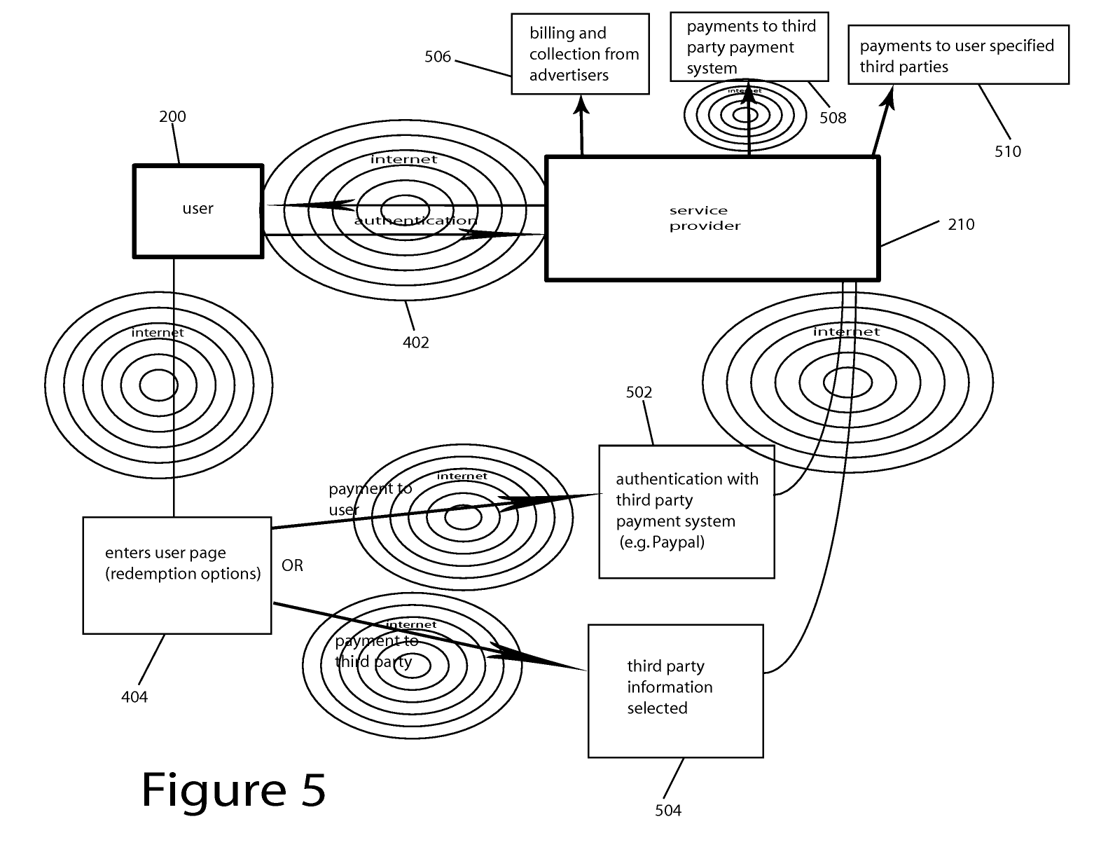

The inventive method presented herein comprises a method of providing reward-compensated targeted advertising via the Internet as shown in FIG. 1. Users and advertisers are registered (step 102) with a service provider, as shown in more detail in FIG. 2, who then selects (step 104) individual users, as shown in more detail in FIG. 3, to view content from individual advertisers based on the minimum threshold compensation reward level set by the individual users. The users are compensated (steps 106 and 108), as shown in more detail in FIGS. 4 and 5, for viewing the advertising content based on the reward level set by the advertiser.

### User Registration

As shown in the schematic in FIG. 2, users 200 register for the service through the service provider 210. Registration requires submission of basic personal information (date of birth, name, location, income, marital status), which is used to target advertising, as well as agreement with the Terms of Use for the service (step 202). During registration, or at any time thereafter, the user can provide more detailed information, preferably in response to more comprehensive forms (favorite sports teams, musical groups, actors, etc.) that enables more selective advertising targeting.

In addition, the user is required to provide financial information that is used for user compensation and rewards, is the form of money or money equivalents. Preferably, the information provided is a credit card number and authorization, or to an electronic payment account (e.g. PayPal™) to which monetary compensation can be directly provided to the user. Alternatives include awarding the user's compensation to third party associates and organizations (e.g. Facebook, MySpace), including donations to charitable organizations and social projects. More generally, user compensation and rewards can take almost any form, including, but not limited to, gift cards or other prepaid cards, coupons or discounts on goods and services, and credits or scrip (e.g. Microsoft Points).

The last step is for the user to set a minimum offer threshold for receiving advertisements (step 204). That is, the minimum reward that the advertiser is offering for viewing and/or participating in the advertising campaign. The user is then only provided with advertising offers meeting the minimum threshold set. The user information and authorization for receiving advertisements and compensation is exchanged (step 206) between the user 200 and the service provider 210 over the Internet as needed to ensure the information is up-to-date and meets both parties requirements.

In addition to setting a minimum offer threshold, the user can also set priorities and preferences for third party compensation. For example, a user can set a preferred charitable organization as their first compensation choice, a political organization as their second choice, and direct monetary compensation as their third choice. The user can set as many compensation options and rankings as they desire, subject to any restrictions imposed by the service provider.

The service provider can choose to restrict the number of compensation options available to users and advertisers in order to prevent abuse of the selection system. Similar restrictions can be applied to disallow selection of diametrically opposed organizations (particularly political and quasi-political organizations).

Another method of preventing abuse is by applying (Boolean) logic to user and advertiser choices during the matching process. In addition to selecting different compensation options, a user may desire to support certain organizations, and not to support other organizations. In order to meet their desire, the user can further apply logical arguments to extend their selection criteria. Thus, a user can include the criteria of participating with advertisers that support organization A, but not organization B (A NOT B). Or, the user can include criteria for supporting organization A, and any one or organizations B, C, or D (A AND (B OR C OR D)). More generally, any combination of logic operators can be applied by the user to further refine their selection criteria. Similar, advertisers can apply logic operators as part of the user selection and compensation process.

In one embodiment, to view the advertising offers, the user logs in to a personal homepage 230 generated by the service provider 210, where the offers are displayed. The user can then view and/or participate in the displayed offers and is credited according to the reward specified for each offer. Additionally, if permitted by the advertiser, the user can forward the offer to others after viewing.

Once viewed, offers are marked as “viewed” and are moved to a separate page for later re-viewing (without any credit/reward received). The criteria for marking an offer as “viewed” are set by the advertiser, however, the standard requirement is that the advertising offer (typically a video) be viewed to completion by the user to earn credit. Mere display of an offer would not credit the user until the actual content is viewed.

In an alternative embodiment, the advertising offers 232 are generated by the service provider 210 and provided on homepages or front pages of websites that the user visits. These websites can be provided by the user as part of the registration process, or can be selected by the advertiser with the expectation that the user will be accessing one or more of the websites on a regular basis. In the latter case, the websites the user visits can be tracked and added to their profile.

For example, on registration, the user can identify themselves as a member of a social networking service, such as Facebook. Then, when the user later logs in to the Facebook website, the advertising offers will appear at that website, at the login page or on the user's profile page.

In this embodiment, advertisements are displayed on the website, in the same fashion as conventional advertisements (e.g. interstitial, sidebar, in-line), however, the displayed advertisement concludes with an acknowledgement box for the user to click, so that confirmation of viewing the advertisement is sent back to the system. Preferably, the user is identified as part of their login process to the website, however, for websites where that is not possible, a login box can be optionally included at the start or end of the advertisement. Similarly, other options, such as re-viewing and recommending to another user, can also be provided at the end of the advertisement. As above, the user is typically required to select the advertisement and view it to completion in order to earn reward credit.

To restrict system abuse and promote security, every user account requires an associated payment account. User accounts are not permitted to be associated to multiple payment accounts (awarding credits to third parties is not considered as another payment account). Furthermore, IP address tracking is enabled to prevent multiple user accounts or payments accounts from the same IP address. If the user agrees upon or after registration, the IP address tracking can also be used to expand the user's profile with a list of visited websites and frequency of visits. This profile information, unattached to the user's identity, can then be used to solicit advertisers as further discussed herein.

### Advertiser Registration

Following the schematic in FIG. 2, advertisers 220 also create individual accounts with the service provider 210 in a similar manner to the users. Advertisers sign up and provide their identity information (step 222) to the service provider, and then change and update this information via the Internet (step 226). Advertisers can pay either a regular (annual or monthly) subscription fee, or on a per-campaign basis. Once registered, the advertisers then submit advertising campaigns containing the advertising offers to the users following the schematic in FIG. 3. The number or frequency of the advertising campaigns is limited only by the funds the advertiser is willing to contribute in support of the campaigns.

An advertising campaign includes advertising content, rewards and targets. The content is determined by the advertiser, but is also subject to approval by the service provider. Approval of content is not limited to the actual advertising message, but also to the format (audio/video), length, compatibility (i.e. compression formats) and other technical aspects.

The targets for the campaign are the users, and the advertiser submits criteria for selecting the targeted users as a combination of demographics and rewards. The reward selection is based on the options offered to the users as described above, including the application of logic operators as part of the selection criteria.

To launch a campaign, the advertiser 220 logs in to a secure webpage (step 302) and is authenticated (step 304) by the service provider 210. The advertiser can then perform a qualification query (step 306) to determine the number of potential users that meet the campaign criteria. The anonymized results are returned (step 308) to allow the advertiser to determine whether or not to proceed with the campaign. If the results are unsatisfactory, revised queries can be sent (step 3 10).

Once the advertiser accepts the result, the full campaign information, including the user qualifications, compensation offer, and advertising content, is sent (step 312) to the service provider, who approves the campaign. The service provider then generates (step 314) the list of qualified users and sends out (step 316) the content based on each user's stated preferences.

Targets are set based on the financial allocation to the campaign, and also on marketing data gained from the service provider. Targets and associated rewards are typically set based on the expected target audience, which can be more accurately determined from the list of registered users than in a conventional unsolicited advertising campaign. Advertisements can be passive, simply to be viewed by the user, or active, and directly solicit a user response to the advertisement.

Advertisements that solicit a direct user response are referred to as “challenge” advertisements. Challenge advertisements allow the advertiser to create tiered campaigns and reward systems, where users receive better rewards for responding to the challenge advertisement as opposed to merely viewing it. Additionally, users who respond to the challenge advertisement can become eligible for participation in a future campaign (or extension of the existing campaign), preferably offering greater than normal rewards for participation.

Once the campaign is ready for launch, the advertiser purchases credits from the service provider to reflect the expected user response. If additional credits are needed, they can be purchased, or the campaign terminated, if based on a fixed budget. Unused credits are cashed out and refunded to the advertiser, reducing the financial risk of a failed campaign.

### Feedback

The system tracks the number of views for each advertisement in a campaign, as well as the total number of views for the campaign. In addition to the views, the user response to the advertisement is also tracked. In particular, the number of times the user forwarded the advertisement is noted, along with the user receiving the forwarded advertisement, allowing for improved targeting for future campaigns aimed at the same target audience.

Feedback on challenge advertisements is also tracked and compared to the number of views to assess the response percentage associated with particular types of challenges. In addition, where direct user feedback to the advertiser is permitted, this feedback is tracked and the content forwarded to the advertiser, possibly anonymously, if desired by the user.

### Rewards Compensation and Redemption

On the user side, upon viewing and/or responding to the advertisement, the user is credited according to the parameters set out in the advertising campaign as shown in FIG. 4. The user 200 is authenticated (step 402) by the service provider 210 and access their user page 404. In certain embodiments, rather than a user page, the user would log in directly to the advertisement. The service provider then sends out (step 406) advertisements from its current campaign inventory that meet the user's preferences. The advertisement are then viewed by the user (step 408) and the viewing information is logged by the service provide (step 410). The logged information is then used to update the user's status and user page accordingly (step 412).

The user is then able to cash out (redeem) their credits (less a transaction percentage) with the service provider to receive the cash equivalent in their associated electronic payment account according to the schematic in FIG. 5. The authenticated user merely selects their payment options from their user page 404. The user can receive a cash payment directly into their assigned electronic account (step 502). Alternatively, the user can assign the credits (and thus the corresponding cash equivalent) to a third party organization (i.e. a Facebook account) or as a donation to a philanthropic or charitable organization (step 504). In order to encourage contributions, a lower transaction percentage can be applied to donations.

The service provider 210 then coordinates all financial transactions, including billing and collecting from advertisers for their campaigns (step 506), making payment to electronic user accounts (e.g. PayPal) (step 508), and making payment to the user-specified third parties (step 510) where authorized.

For embodiments where the advertising campaign operates through a social networking or similar service website, credits can be accumulated based on the website where the advertising offers are viewed. For example, viewing an advertisement on Facebook can give the user credits associated with their Facebook profile (at a predetermined rate of exchange), and the same user viewing an advertisement on BlogSpot would receive credits generally tied to their profile with the service provider.

The advertiser is debited for credits accumulated by users for a specific campaign. In addition, a handling fee (fixed or percentage) is collected by the service provider.

A variant on the traditional advertising campaign is a donation campaign. With the user's ability to donate credits to a philanthropic or charitable organization, the organization (or the service provider) can be provided with donation tracking in the same manner as advertising tracking for advertisers. Additional, a personal donation tracker can be added to the user's home page, and a global tracker to the service provider's home page, similar to those already known.

While the above method has been presented in the context of Internet-based advertising on personal computers, the method is equally applicable to other forms of advertising and other communication devices.

This concludes the description of a presently preferred embodiment of the invention. The foregoing description has been presented for the purpose of illustration and is not intended to be exhaustive or to limit the invention to the precise form disclosed. It is intended the scope of the invention be limited not by this description but by the claims that follow.

What is claimed is:

1 A method of providing reward-compensated advertising, comprising:
a) registering one or more advertisers with a service provider;
b) registering one or more users with the service provider;
c) selecting individual users from said one or more users to view advertising content from an individual advertiser selected from said one or more advertisers based on a reward level set by the individual user; and
d) compensating the individual user for viewing the advertising content based on the reward level set by the individual advertiser.

2. The method of claim 1, wherein said step of registering said advertisers and said users includes providing a list of preferred reward amounts and types, and wherein said types of preferred reward amount can include monetary compensation directed to third parties.

3. The method of claim 2, wherein said step of selecting individual users includes applying Boolean logic to said user lists of preferred reward amounts and types, and to said advertiser lists of preferred reward amounts and types.

4. The method of claim 1, wherein the advertising content comprises an interactive message that solicits a direct response from the user.

5. The method of claim 4, wherein the user receives greater compensation as a result of responding to the solicitation.

6. The method of any of claim 1, wherein user selection is additionally based on demographic data submitted by the user during registration.

7. The method of any of claim 6, wherein user selection is additionally based on data collected by monitoring website visitation habits of the user.

8. The method of claim 1, wherein the user is permitted to assign their compensation to a third party.

9. The method of claim 8, wherein the user is permitted to provide multiple third parties as compensation options, and is further able to use logic operators to combine and exclude third parties for selection as part of said step of selecting individual users.

10. The method of any of claim 1, wherein the advertising content is provided on a restricted-access homepage provided to the user.

11. The method of any of claim 1, wherein the advertising content is provided on existing websites

12. A system for connecting advertisers and users for targeted advertising, comprising:
a) a database of individual users, with information for each individual user comprising demographic information for said individual user, and compensation preferences for said individual user as set by said individual user,
b) a database of individual advertisers, with information for each individual advertiser comprising demographic target information for advertising campaigns for said individual advertisers, and compensation rewards for each advertising campaign, as set by said individual advertiser, and
c) a selection engine, operative to compare individual user information from the individual user database with advertiser information from the individual advertiser database and to produce a list of one or more individual users as targets for said each advertising campaign from said individual advertiser.

13. The system of claim 12, wherein said individual user compensation preferences include multiple forms of compensation, with one of said forms of compensation being monetary compensation directed to a third party as a donation.

14. The system of claim 13, wherein said selection engine applies Boolean logic to produce said list of users based on the multiple forms of compensation set by each said individual user and preferences set by said individual advertiser.
